(19) United States
(12) Patent Application Publication
(10) Pub. No.: US 2025/0245621 A1
(43) Pub. Date: Jul. 31, 2025

(54) AUTOMATED FRESH FOOD INVENTORY MANAGEMENT

(71) Applicants: ASRAR DAMDAM, JEDDAH (SA); CAGRI KAAN OZCAN, ANKARA (TR); LEVENT OSMAN OZAY, ANKARA (TR); RAGHAD HELABI, JEDDAH (SA)

(72) Inventors: ASRAR DAMDAM, JEDDAH (SA); CAGRI KAAN OZCAN, ANKARA (TR); LEVENT OSMAN OZAY, ANKARA (TR); RAGHAD HELABI, JEDDAH (SA)

(21) Appl. No.: 18/663,074

(22) Filed: May 14, 2024

(30) Foreign Application Priority Data
Jan. 25, 2024 (SA) SA 1020240371

(51) Int. Cl. G06Q 10/087; A23B 7/015; B65B 25/04; B65B 55/16; G06Q 10/0832

(52) U.S. Cl. CPC G06Q 10/087; A23B 7/015; B65B 25/041; B65B 55/16; G06Q 10/0832

(57) ABSTRACT

A method for automated fresh food inventory management, comprising: sterilizing a food item using UV-C irradiation to deactivate a plurality of spoilage and harmful microorganisms using a UV-C light conveyor system; after the sterilization using the UV-C irradiation, packaging the food item; implementing a data collection about the food item comprising a package marking with information about the food item, a time of UV-C irradiation of the food item and a packaging information of the food item; implements storage or shipping operations; after the packaging process is completed, storing the packaged food item in a chiller on-site, wherein before shipping, when the packaged food item is loaded onto a delivery transport vehicle, a handheld terminal is used to instantly scan the RFID tags of all packages simultaneously; tracking the packaged food item by obtaining and storing in a server.

### BACKGROUND

Each year, approximately one-third of the world's food production goes to waste, with a considerable amount being attributed to inadequate storage and transportation conditions for fresh foods. Accordingly, there is a need for technical innovations that provide the ability to significantly extend the shelf-life for a variety of food items, including fresh produce, meat, and baked goods, while simultaneously preserving their sensory qualities, such as taste, appearance, texture, and aroma. Disclosed herein are various innovative AIoT solutions provided to maximize the shelf-life of fresh produce without the need for chemicals, accomplishing this in a matter of seconds.

### SUMMARY OF THE INVENTION

In one aspect, a method for automated fresh food inventory management, comprising: sterilizing a food item using UV-C irradiation to deactivate a plurality of spoilage and harmful microorganisms using a UV-C light conveyor system; after the sterilization using the UV-C irradiation, packaging the food item; implementing a data collection about the food item comprising a package marking with information about the food item, a time of UV-C irradiation of the food item and a packaging information of the food item; implements storage or shipping operations; after the packaging process is completed, storing the packaged food item in a chiller on-site, wherein before shipping, when the packaged food item is loaded onto a delivery transport vehicle, a handheld terminal is used to instantly scan the RFID tags of all packages simultaneously; tracking the packaged food item by obtaining and storing in a server: a destination for transporting the packaged food item, a quantity of each food type in kilograms, at least one scan information of the packaged food item, and at least one transportation status of the packaged food item; and automatically monitoring a transportation status and a freshness status of the packaged food item.

### BRIEF DESCRIPTION OF THE DRAWINGS

FIG. 1 illustrates an example system for automating fresh food inventory management, according to some embodiments.

FIG. 2 illustrates an example process for automating fresh food inventory management, according to some embodiments.

FIG. 3 illustrates an example view of a portion of a UV-C light conveyor system, according to some embodiments.

FIGS. 4 and 5 illustrate example food item package markings, according to some embodiments.

FIG. 6 illustrates an example process for implementing a bags usage scenario, according to some embodiments.

FIG. 7 illustrates an example process for implementing a containers usage scenario, according to some embodiments.

FIG. 8 shows an example schematic of the weighing of produce for storage in a MAP bag(s), according to some embodiments.

FIG. 9 shows an example schematic of IOT scaling device, according to some embodiments.

FIG. 10 illustrates an example screenshot for implementing a multiple IOT scaling devices in parallel, according to some embodiments.

FIGS. 11-13 illustrate example screenshots showing software monitoring operations, according to some embodiments.

FIGS. 14-16 illustrates an example screen shots of dashboard views that enable customers to visualize the waste reduction improvement overtime in addition to the reduction in their carbon footprint due to the use of the Foodline product, according to some embodiments.

FIG. 17 illustrates an example schematic of an IoT Scaling and Vacuuming Device, according to some embodiments.

FIG. 18 illustrates an example schematic of an IoT Tracking Device, according to some embodiments.

FIG. 19 illustrates an example IOT scaling device, according to some embodiments.

FIG. 20 depicts an exemplary computing system that can be configured to perform any one of the processes provided herein.

The Figures described above are a representative set and are not exhaustive with respect to embodying the invention.

### DESCRIPTION

Disclosed are a system, method, and article of processing for automated fresh food inventory management. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Artificial Intelligence of Things (AIoT) is the combination of Artificial intelligence (AI) technologies with the Internet of things (IoT) infrastructure to achieve more efficient IoT operations, improve human-machine interactions and enhance data management and analytics.

Deep neural network (DNN) is an artificial neural network (ANN) with multiple layers between the input and output layers. The DNN finds the correct mathematical manipulation to turn the input into the output, whether it be a linear relationship or a non-linear relationship. The network moves through the layers calculating the probability of each output. For example, a DNN that is trained to recognize dog breeds will go over the given image and calculate the probability that the dog in the image is a certain breed. The user can review the results and select which probabilities the network can display (e.g. above a certain threshold, etc.) and return the proposed label.

Deep learning is part of a broader family of machine learning methods based on artificial neural networks with representation learning. Learning can be supervised, semi-supervised or unsupervised.

Load cell converts a force such as tension, compression, pressure, or torque into a signal (e.g. electrical, pneumatic or hydraulic pressure, or mechanical displacement indicator) that can be measured and standardized. A Load cell can be a force transducer. As the force applied to the load cell increases, the signal changes proportionally. Example load cells can be, inter alia: pneumatic, hydraulic, and strain gauge types for industrial applications.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Modified atmosphere packaging (MAP) is the practice of modifying the composition of the internal atmosphere of a package in order to improve the shelf life. MAP films can be used to control the humidity level as well as the gas composition in the sealed package are beneficial for the prolonged storage of fresh fruits, vegetables and herbs that are sensitive to moisture. These films are commonly referred to as modified atmosphere/modified humidity packaging (MA/MH) films. In some embodiments, form-fill-seal packaging machines, the main function is to place the product in a flexible pouch suitable for the desired characteristics of the final product. These pouches can either be pre-formed or thermoformed. The food can be introduced into the pouch, the composition of the headspace atmosphere is changed within the package; it is then heat sealed.

Radio-frequency identification (RFID) uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data, usually an identifying inventory number, back to the reader. This number can be used to track inventory goods.

SIM card (Subscriber Identity Module) is an integrated circuit (IC) intended to securely store an international mobile subscriber identity (IMSI) number and its related key, which are used to identify and authenticate subscribers on mobile telephone devices.

Ultraviolet germicidal irradiation (UVGI) is a sterilization technique employing ultraviolet (UV) light, particularly UV-C (180-280 nm), to kill or inactivate microorganisms. UV-C wavelengths demonstrate varied germicidal efficacy and effects on biological tissue. Many germicidal lamps like low-pressure mercury (LP-Hg) lamps, with peak emissions around 254 nm, contain UV wavelengths that can be hazardous to humans. In some embodiments, the application of wavelengths between 200-235 nm (e.g. far-UVC) can be used for surface and air sterilization.

### Example Methods and Systems

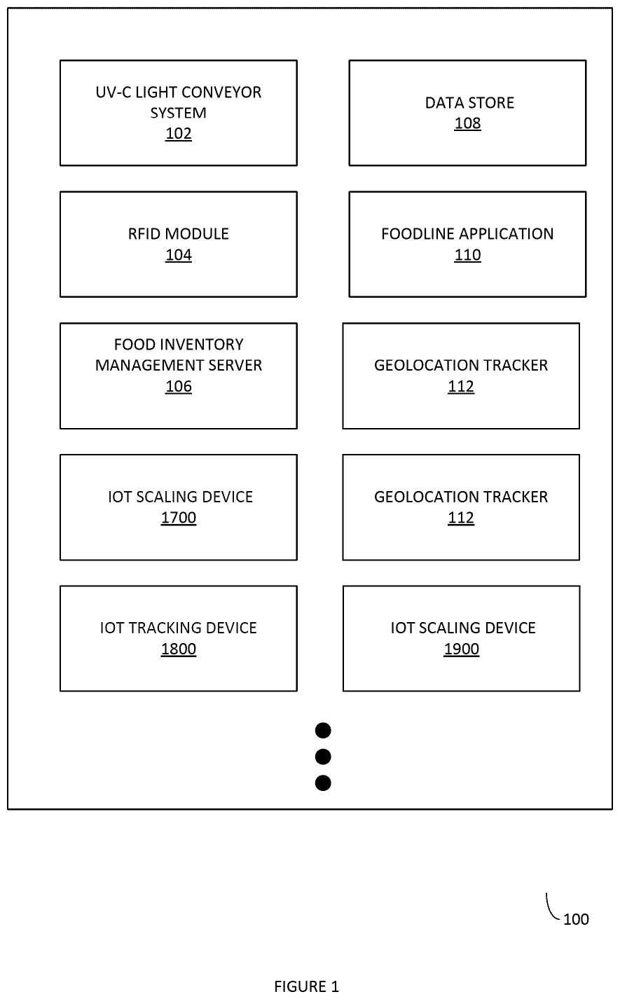

FIG. 1 illustrates an example system 100 for automating fresh food inventory management, according to some embodiments.

System 100 can be an advanced AI-powered software that automates fresh food inventory management, accurately predicts the spoilage of produce, and provides real-time traceability throughout the entire journey of food from farms to distribution centers, retailers, restaurants, hotels and consumers. This seamless integration of food traceability is vital for ensuring complete transparency and accountability within the food supply chain, playing a pivotal role in guaranteeing food safety, thwarting widespread outbreaks, and meticulously monitoring compliance with stringent quality standards and regulatory requirements.

Furthermore, the implementation of food traceability holds paramount importance in enhancing environmental sustainability and efficiency by effectively tracking the production and distribution of food. This invaluable capability enables the optimization of processes, leading to substantial reductions in both loss and waste.

To summarize, system 100 can provide an AIoT solution comprehensively addresses the urgent issue of food waste and ineffective storage by significantly extending shelf-life, while also offering real-time traceability and contributing towards the achievement of environmental sustainability and efficiency objectives within the food industry. The shelf-life extension is achieved using the UV-C conveyor and the packaging material (e.g. either MAP bags or vacuum containers).

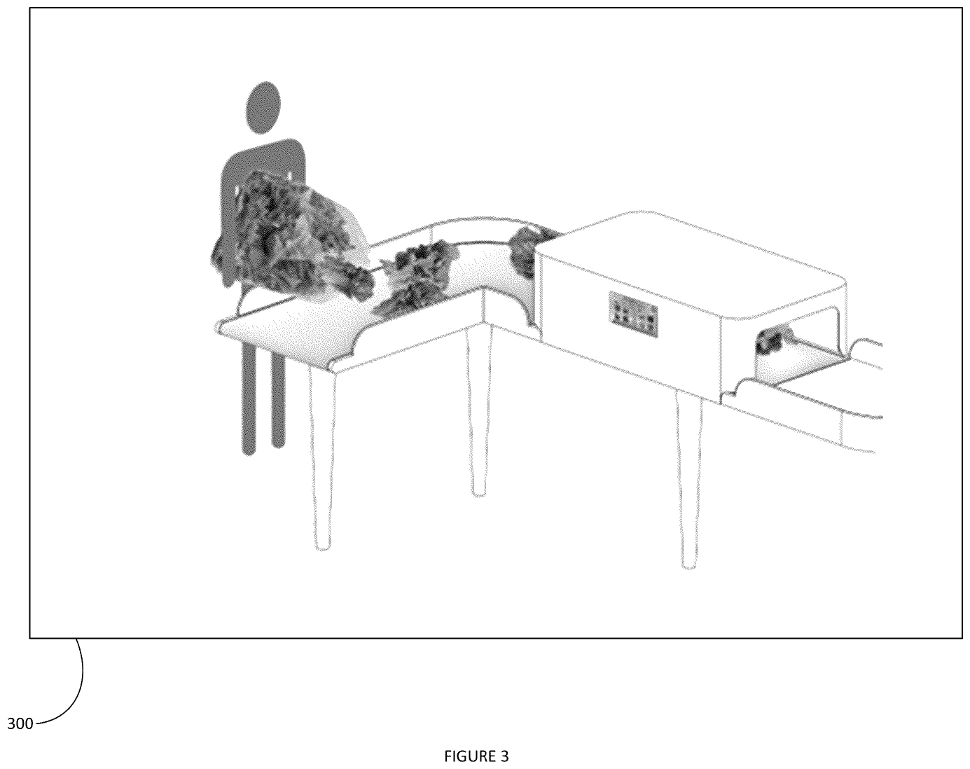

System 100 includes UV-C light conveyor system 102. UV-C light conveyor system 102 is equipped with a screen and a control unit that enables the adjustment of dosages according to the specific type of fresh produce being treated. FIG. 3 illustrates an example view 300 of portion of a UV-C light conveyor system 102, according to some embodiments.

For example, users can select the desired produce, such as “tomato,” from the screen and place the tomatoes onto the conveyor for sterilization. When it is time to treat a different type of fresh produce, such as lettuce, users can simply choose “lettuce” from the screen, and the UV-C irradiation dose will be automatically adjusted for optimal sterilization. This advanced UV-C irradiation control mechanism ensures maximum effectiveness while mitigating the risk of unwanted side effects like a burning smell or browning of the fresh produce.

The UV-C light conveyor system 102 offers precise and customizable sterilization qualities, safeguarding the integrity and sensory attributes of fresh produce without compromising on efficacy.

RFID module 104 can obtain food item data and store it for tracking and traceability operations. RFID module 104 can provide/print/generate RFID tags, as well as barcodes and/or QR codes for both the MAP bags and vacuum containers. The food storage data can be stored in data store 108. Data store 108 stores data related to the various operations of system 100 for automating fresh food inventory management.

Food inventory management server 106 can implement the various functionalities and processes provided herein.

Foodline application 110 can be a mobile device application. Foodline application 110 can enable drivers or operation managers to easily specify the destination for transporting the fresh produce. In addition, it enables real time tracking of the fresh produce during transportation. This allows for the accurate relay of crucial information to the server, including the intended destination where the packages can ultimately arrive, the quantity of each food type in kilograms, as well as the relevant details regarding the assigned truck and driver. Foodline application 110 can provide a dashboard interface with various tracking information (e.g. as obtained via geolocation tracker 112, etc.). Geolocation tracker 112 can implement various geolocation functionalities of system 100. These can include, inter alia: food bag tracking, container trucking, shipping and delivery truck tracking. This can also be served as a web-based application as well in some example embodiments.

Storage layer 114 can be used to implement shelf-life extension. The shelf-life extension is achieved using the UV-C conveyor and the packaging material (e.g. either MAP bags or vacuum containers).

Compact tracking device 112 can include systems (e.g. GPS tracking systems, etc.) for tracking food inventory and/or vehicles used to transport food inventors. Compact tracking device 112 can incorporate several components including, inter alia: temperature sensors, humidity sensors, a gyroscope sensor, a vibration sensor, and more devices for GPS tracking.

### Example Methods

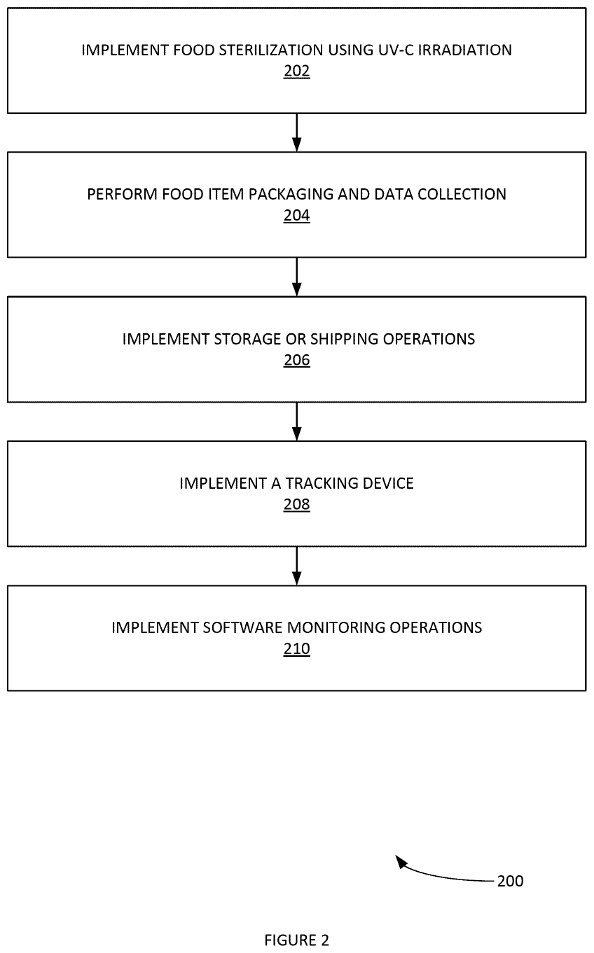

FIG. 2 illustrates an example process 200 for automating fresh food inventory management, according to some embodiments.

In step 202, process 200 implements food sterilization using UV-C irradiation. The usage of UV-C irradiation (e.g. at a wavelength of 254 nm) can be used in deactivating spoilage and harmful microorganisms, thereby extending the shelf life of perishable goods. Process 200 can maintain precise control over the dosage of UV-C light to preserve the sensory qualities of fresh produce, including taste, texture, smell, and appearance. In response to this need, process 200 can use a UV-C light conveyor system (e.g. UV-C light conveyor system 102 discussed supra, etc.) equipped with a screen and a control unit that enables the adjustment of dosages according to the specific type of fresh produce being treated.

For example, users can select the desired produce, such as “tomato,” from the screen and place the tomatoes onto the conveyor for sterilization. When it is time to treat a different type of fresh produce, such as lettuce, users can simply choose “lettuce” from the screen, and the UV-C irradiation dose will be automatically adjusted for optimal sterilization. This advanced UV-C irradiation control mechanism ensures maximum effectiveness while mitigating the risk of unwanted side effects like a burning smell or browning of the fresh produce.

The UV-C light conveyor system 102 offers precise and customizable sterilization qualities, safeguarding the integrity and sensory attributes of fresh produce without compromising on efficacy.

In step 204, process 200 then performs food item packaging and data collection.

After sterilization using UV-C irradiation, users have the option to store fresh produce in either our Modified Atmosphere Packaging (MAP) bags and/or vacuum containers. It is noted that MAP bags increase the shelf-life of fresh produce by modifying the gas composition surrounding the produce, which slows down respiration, inhibits microbial growth, and helps maintain the quality of the produce. Similarly, vacuum-sealed containers provide another method for extending the shelf-life of fresh food while ensuring the preservation of its organoleptic qualities.

The choice between vacuum containers and MAP bags depends on the specific needs and operations of the customer. For example, distribution centers may opt to use our vacuum containers when sending fresh produce to central kitchens as they have the ability to return and reuse these containers. On the other hand, plastic bags may be used for packaging fresh produce intended for household shipping or supermarket shelves, where it is unlikely that these bags will be returned.

It is noted that certain types of fresh produce can have a longer shelf-life when stored in containers, as opposed to bags. Conversely, bags can be more effective for some other types of fresh produce. Therefore, process 200 provides precise recommendations on the most suitable storage medium (e.g. bags or containers) for each type of fresh produce. Nevertheless, if customers are unable to get the containers back from a final destination (e.g. when the packages are sent to households, etc.), they can use bags. Additionally certain customers, such as central kitchens, have the advantage of being able to select the ideal storage medium, as they can retain and reuse the containers.

For tracking and traceability, both the MAP bags and vacuum containers are equipped with unique RFID tags, as well as barcodes and/or QR codes. This can be implemented/managed by RFID module 104. End users as well as all points along the fresh produce supply chain will be able to know the information of each package via reading the Barcode/QR code.

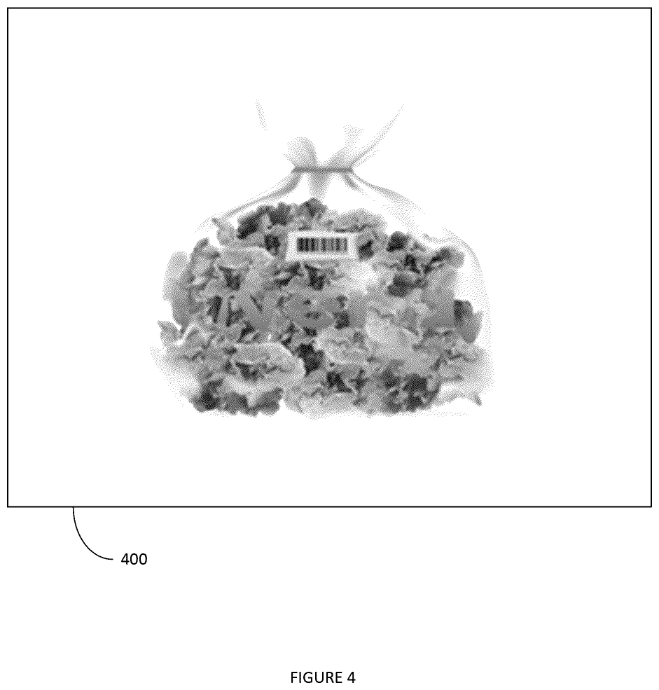

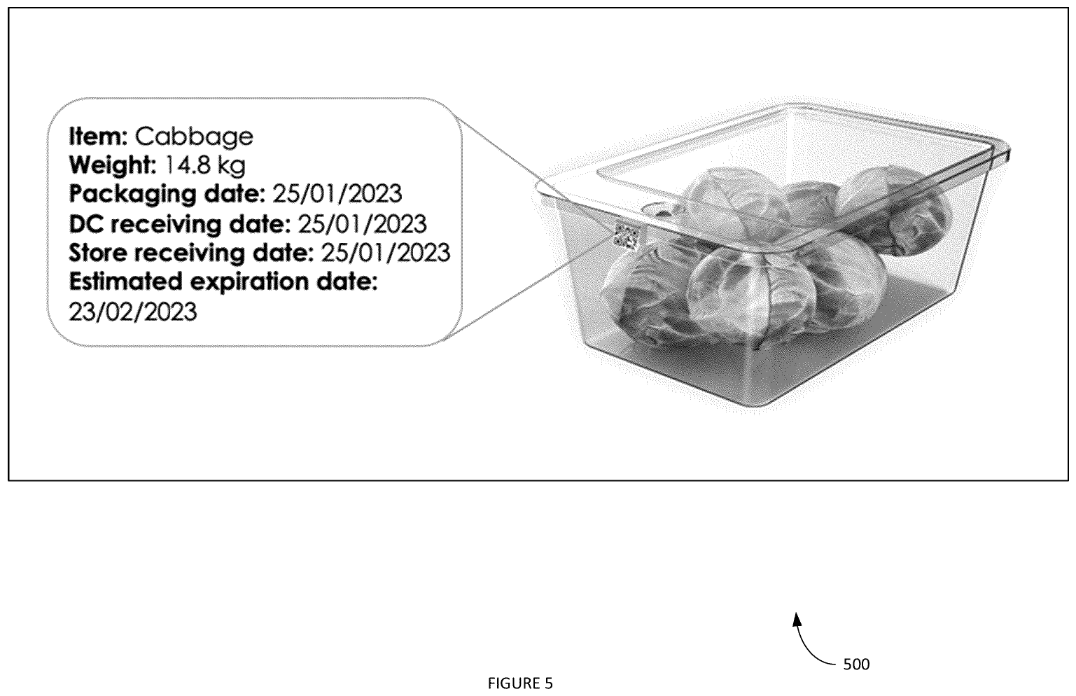

FIGS. 4 and 5 illustrate example food item package markings, according to some embodiments. These can be automatically generated by RFID module 104 and attached to the MAP bag 400 and/or vacuum container 500.

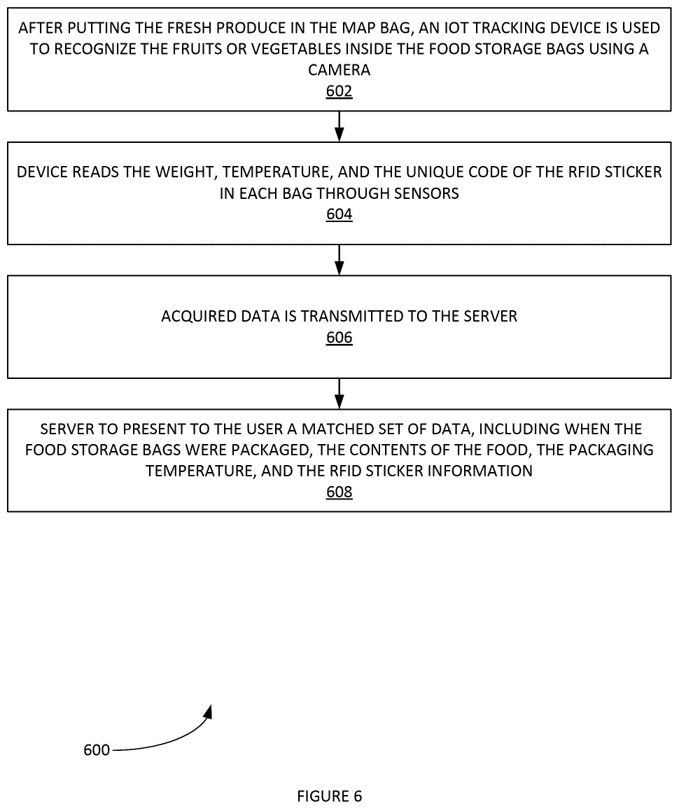

FIG. 6 illustrates an example process 600 for implementing a bags usage scenario, according to some embodiments. After putting the fresh produce in the MAP bag, an IoT tracking device is used to recognize the fruits or vegetables inside the food storage bags using a digital camera in step 602. The weight is also measured by the device. Alternatively, food types can be entered manually using the screen in the IoT device. The device also reads the weight, temperature, and the unique code of the RFID sticker in each bag through sensors in step 604. The acquired data is then transmitted to the server 606. This can be food inventory management server 106, etc. This enables the server to present to the user a matched set of data, including when the food storage bags were packaged, the contents of the food, the packaging temperature, and the RFID sticker information in step 608. It is noted that in another example, manual fresh produce selection can be implemented via a screen in the IoT device.

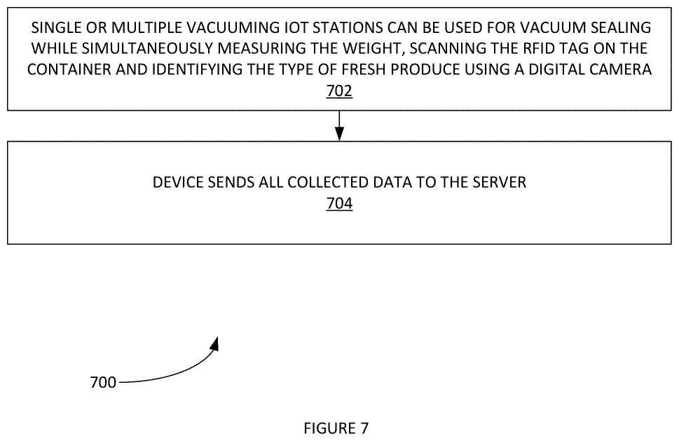

FIG. 7 illustrates an example process 700 for implementing a containers usage scenario, according to some embodiments. A single or multiple vacuuming IoT stations can be used for vacuum sealing while simultaneously measuring the weight, scanning the RFID tag on the container and identifying the type of fresh produce using a digital camera in step 702. Alternatively, the user may use the screen to enter the type of food in the container. The device send all collected data to the server (e.g. food inventory management server 106, etc.) in step 704.

Returning to process 200, in step 206 process 200 implements storage or shipping operations.

After the packaging process is completed at the distribution center, food storage bags (e.g. MAP bags, etc.) and/or containers (e.g. vacuum containers, etc.) are either stored in chillers on-site or shipped directly to restaurants, supermarkets, or households. Before shipping, when the bags/containers are being loaded onto the delivery truck, a handheld terminal is used to instantly scan the RFID tags of all packages simultaneously. Additionally, each truck (and/or other type of transport vehicle) is equipped with a unique RFID tag that is also scanned during this process. As a result, the RFID tags of the fresh produce packages become associated with the truck number in the system, effectively confirming their departure from the distribution center's inventory. By implementing step 206, process 200 can ensure proper tracking and traceability throughout the supply chain, from the packaging phase at the distribution center to the final destination of the products.

In step 208, process 200 implements a tracking device. As noted supra, drivers and/or operation managers can use a Foodline application 110 to specify the destination for transporting the fresh produce. This allows for the accurate relay of crucial information to the server, including the intended destination where the packages will ultimately arrive, the quantity of each food type in kilograms, as well as the relevant details regarding the assigned truck and driver.

Moreover, each truck can be equipped with a compact tracking device that incorporates several components including temperature sensors, humidity sensors, a gyroscope sensor, a vibration sensor, and more devices for GPS tracking. This tracking device allows for the real-time monitoring of different transportation conditions, such as the temperature and humidity levels within the truck storage, the speed of the vehicle, vibration intensity, altitude, and precise location. All this information can be displayed on the web application. Tracking these variables is of utmost importance as fluctuations in temperature and humidity can significantly reduce the shelf-life of the stored fresh produce. Additionally, it has been demonstrated that high levels of vibration can lead to a degradation in the quality of fresh produce, further compromising its shelf-life.

In step 210, process 200 implements software monitoring operations. Process 200 can enable customers to continuously monitor automation of fresh food inventory management.

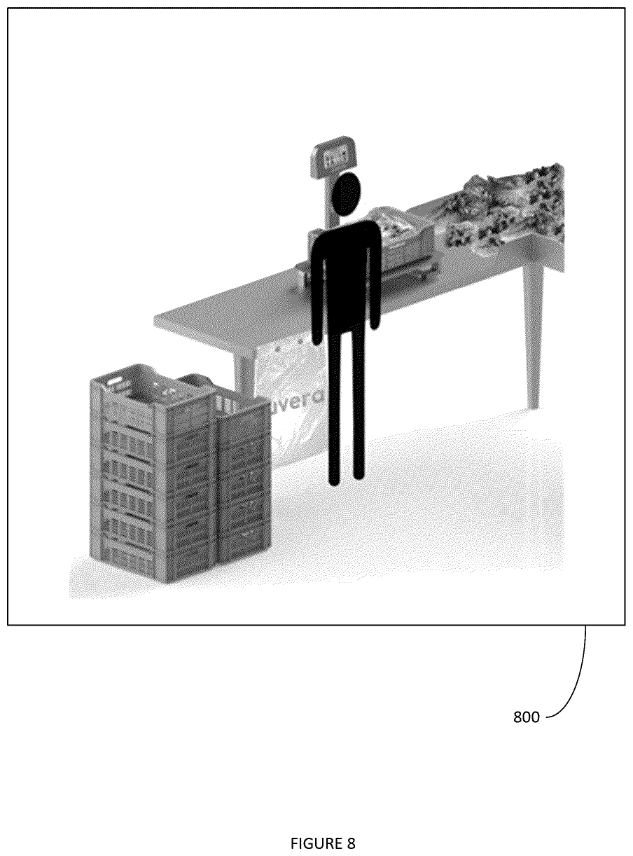

FIG. 8 shows an example schematic 800 of the weighing of produce for storage in a MAP bag(s), according to some embodiments. IoT scaling device 1900 can be utilized to weigh and/or otherwise analyze the food/produce.

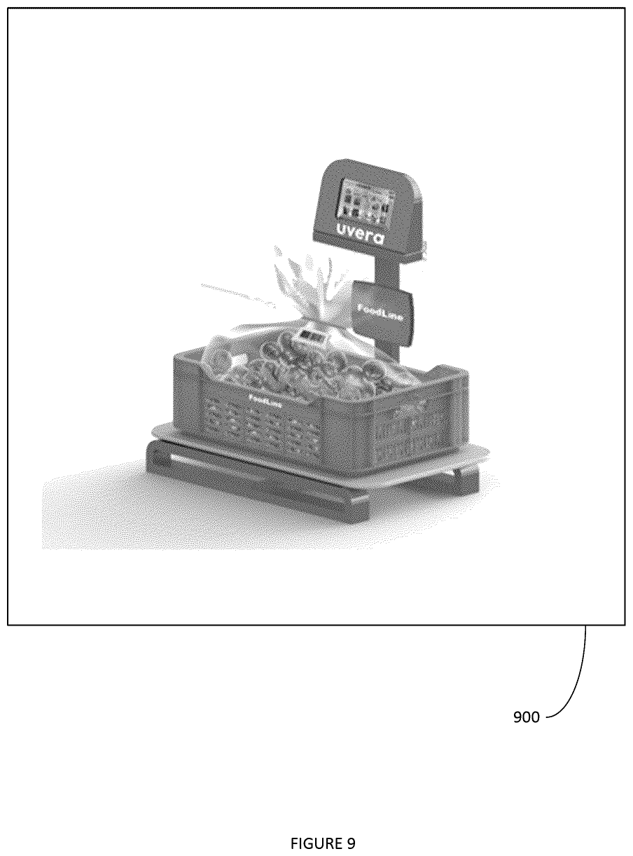

FIG. 9 shows an example schematic 900 of IoT scaling device, according to some embodiments. Schematic 900 shows a physical view of IoT scaling device 1900.

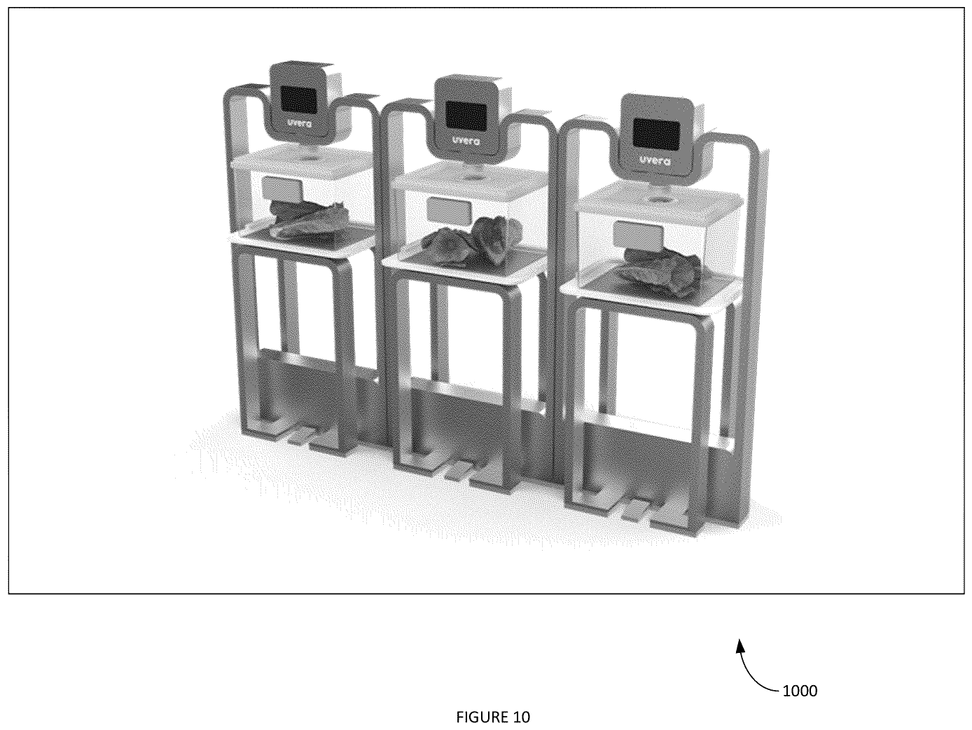

FIG. 10 illustrates an example screenshot 1000 for implementing a multiple IoT scaling devices in parallel, according to some embodiments.

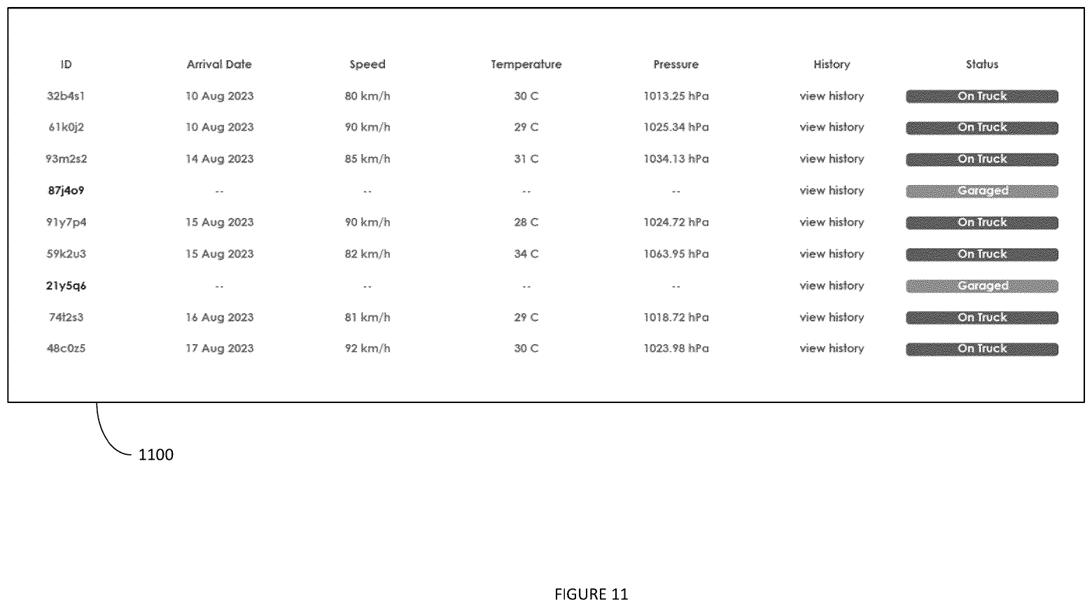

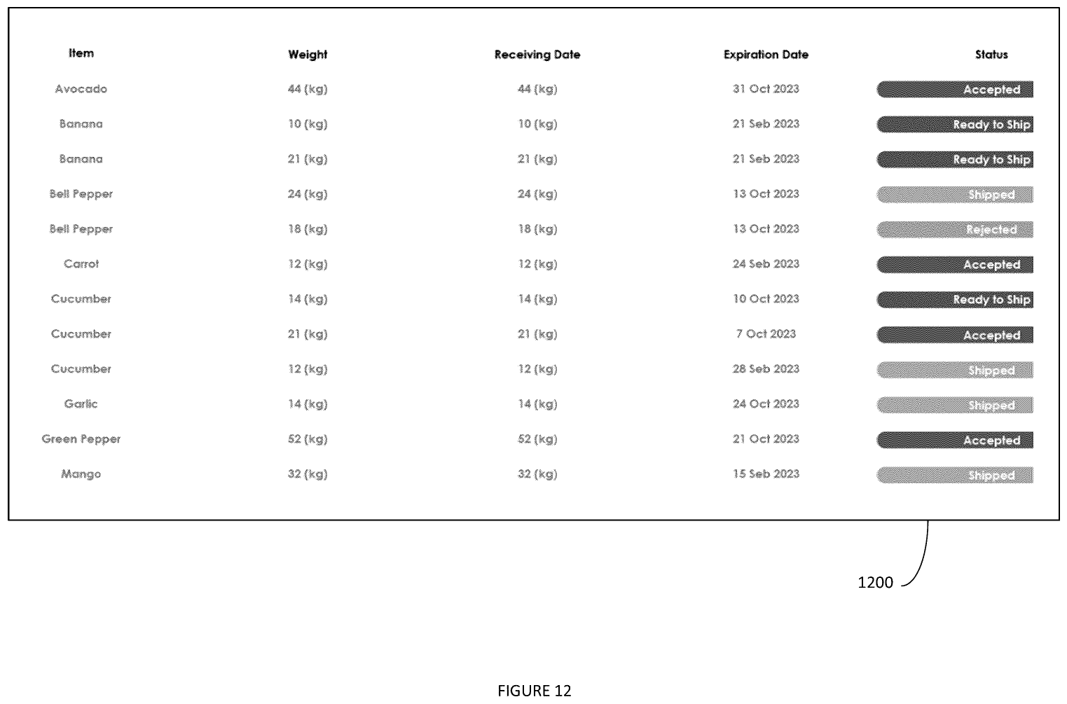

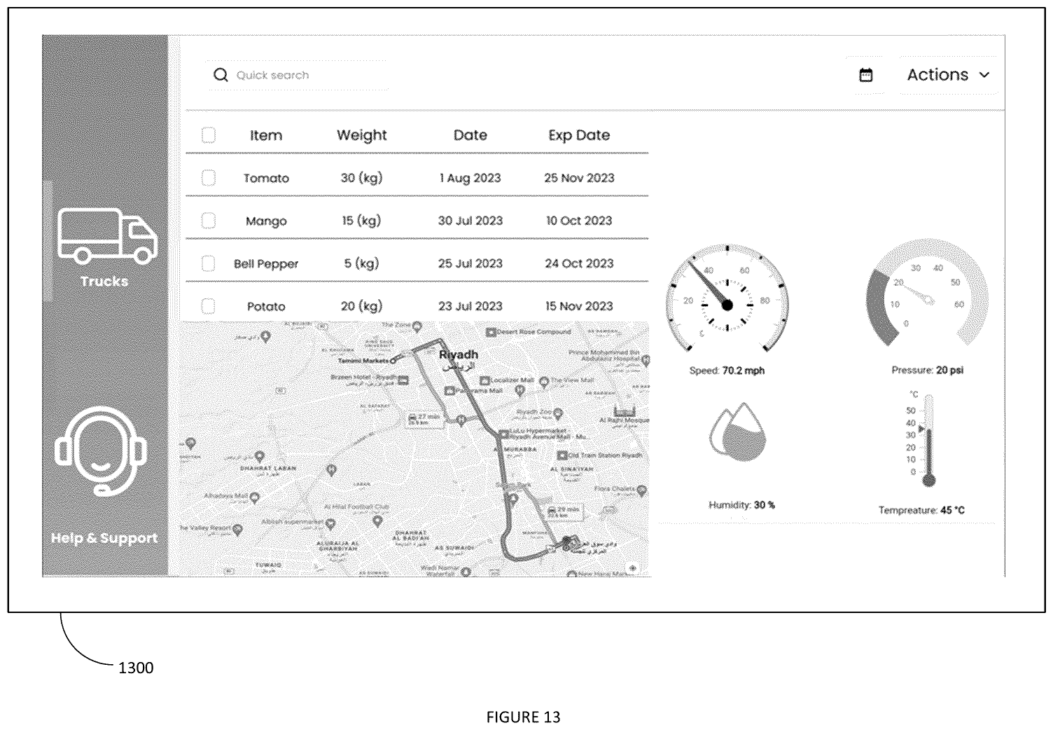

FIGS. 11-13 illustrate example screenshots 1100-1300 showing software monitoring operations. These software monitoring operations can be implemented via a web application (as shown) and/or a mobile device application.

As shown in screenshot 1100, the first tab of the tracking software showcases their stock by displaying all items in kilograms, along with the date of receipt, the estimated expiration date predicted using an AI model, and the current status of each item. Under the Status tab, users will find four options that gets update automatically, inter alia:
Ready to ship: This status indicates that the fresh produce has been packaged, stored in the distribution center, and is ready for shipping;
Shipped: This status is used to indicate that the fresh produce package is currently on a truck for delivery;
Accepted: This status is used to confirm that the fresh produce package has been successfully delivered and has passed the quality control inspection by the end customer, thereby confirming its acceptance; and
Rejected: This status indicates that the fresh produce package has been delivered to the end customer but has been rejected due to quality reasons. As a result, it has been returned to the distribution center.

Regarding screen shots 1200-1300, the second tab in the software showcases the details of the truck that are owned by the distribution center. It shows all relevant information of each truck, such as its status (Garaged/On Track), speed, temperature. Additionally, clicking on the truck ID can show more details about the truck, such as the fresh produce that are in this truck and the location of this truck on the map. Web mapping services can be integrated into the screen shots as well (e.g. screen shot 1300).

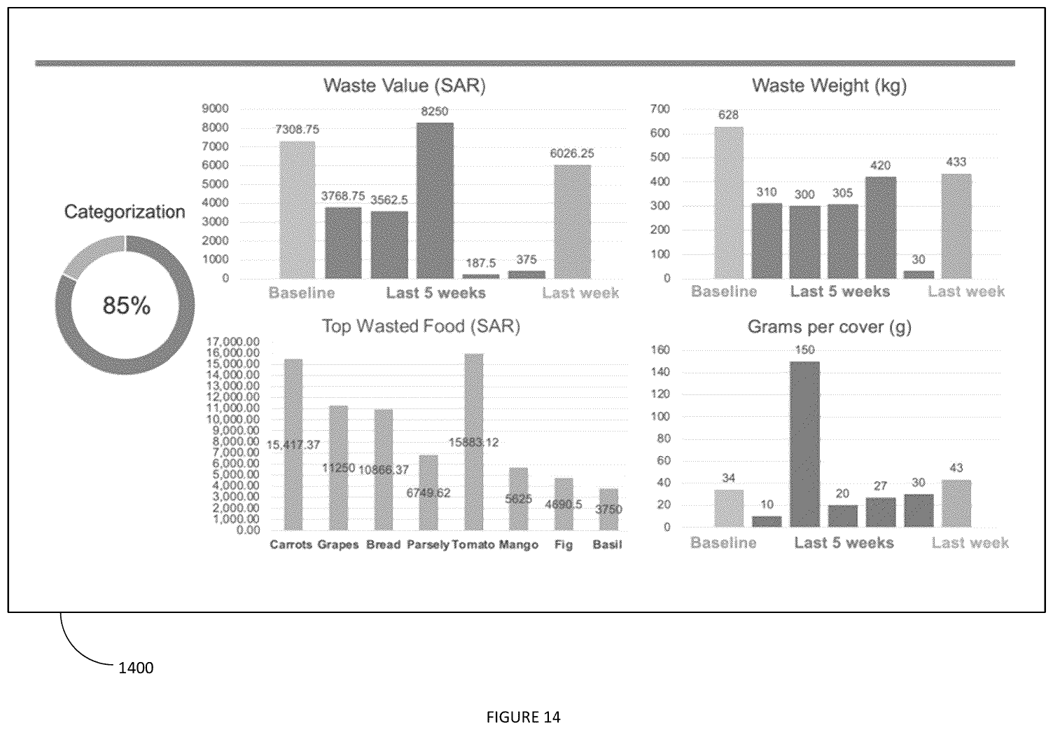

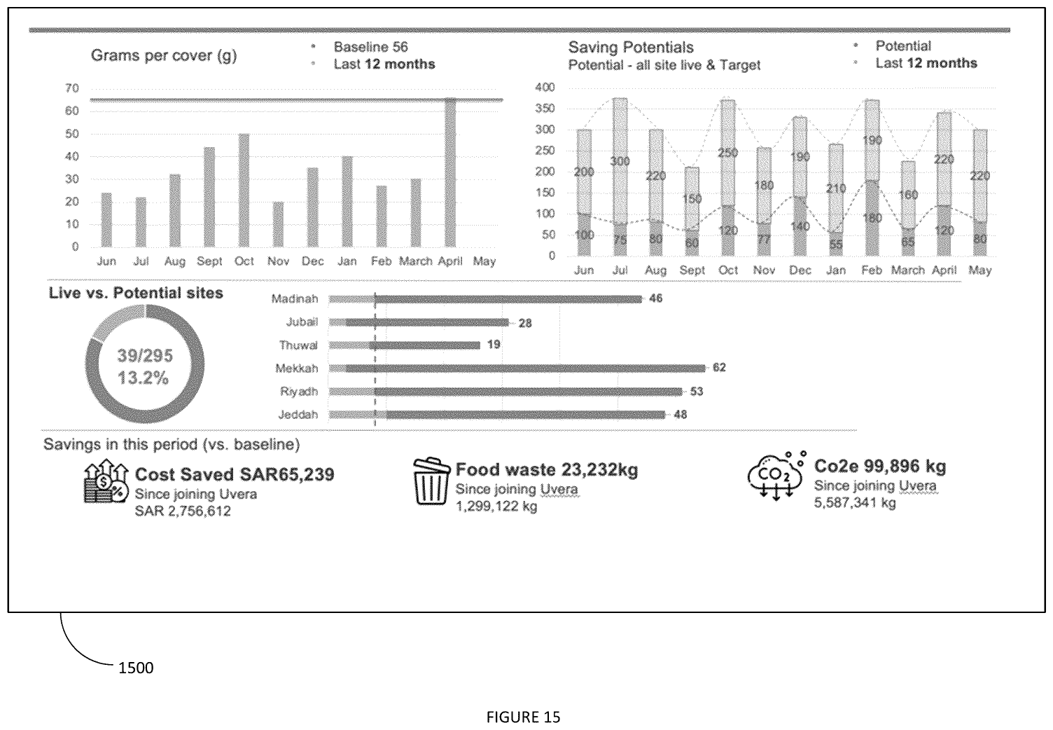

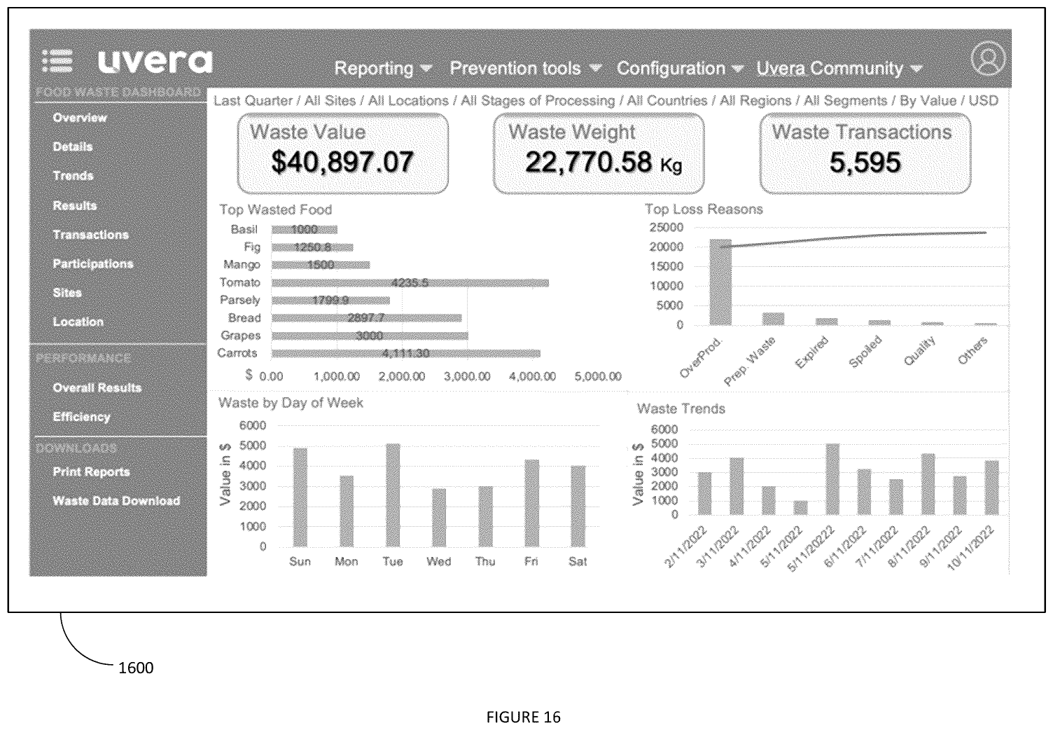

FIGS. 14-16 illustrates an example screen shots of dashboard views that enable customers to visualize the waste reduction improvement overtime in addition to the reduction in their carbon footprint due to the use of the Foodline product, according to some embodiments. Lastly, the data collected will be processed to display various useful information to each customer, such as the weekly waste/item/site, the most wasted fresh produce items, the reasons, the costs. Process 200 can enable customers to visualize the waste reduction improvement overtime in addition to the reduction in their carbon footprint due to the use of the automated fresh food inventory management system 100 and/or process(es) (e.g. process 200) discussed herein.

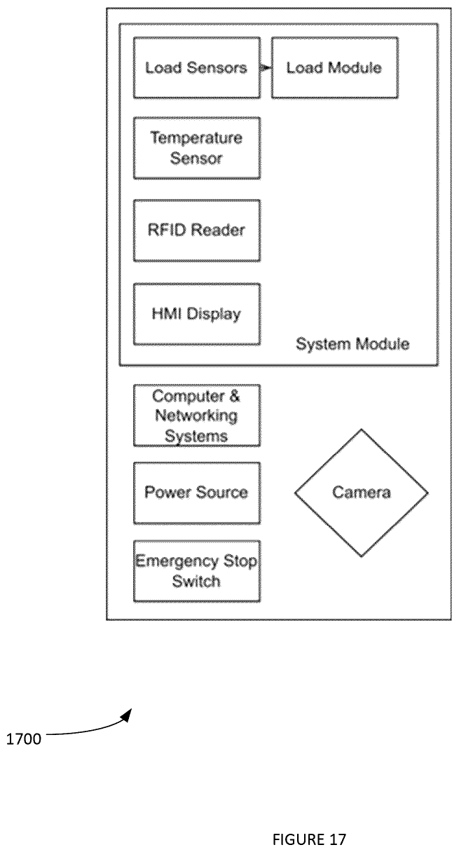

FIG. 17 illustrates an example schematic of an IoT Scaling and Vacuuming Device 1700, according to some embodiments. This can be used to implement aspects IoT scaling device 1900 in some example embodiments, as well as, vacuuming functions. IoT Scaling and Vacuuming Device 1700 can include vacuum systems.

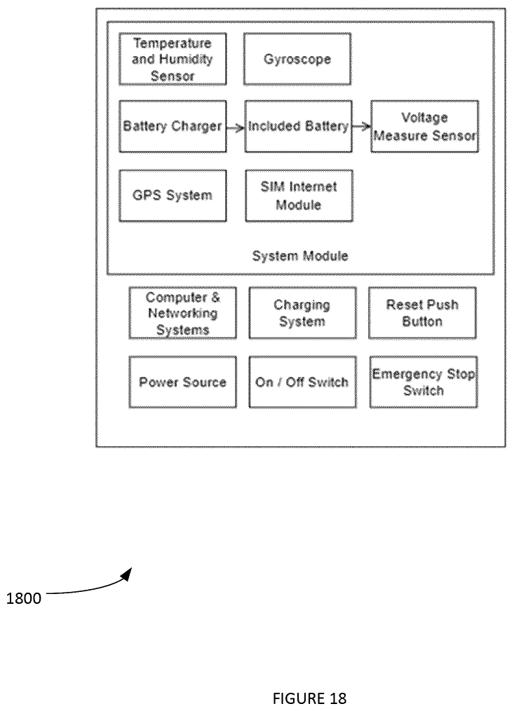

FIG. 18 illustrates an example schematic of an IoT Tracking Device 1800, according to some embodiments. IoT Tracking Device 1800 can include temperature and humidity sensor(s), gyroscopes, etc. IoT Tracking Device 1800 can include a battery charger that can charge the included battery. A voltage sensor can measure battery power. A GPS system and monitor location. A SIM Internet module can interface with the Internet. IoT Tracking Device 1800 can include other systems such as, inter alia: computer and networking systems, charging systems, reset push, buttons, power source(s), on/off switches, emergency stop switches, etc.

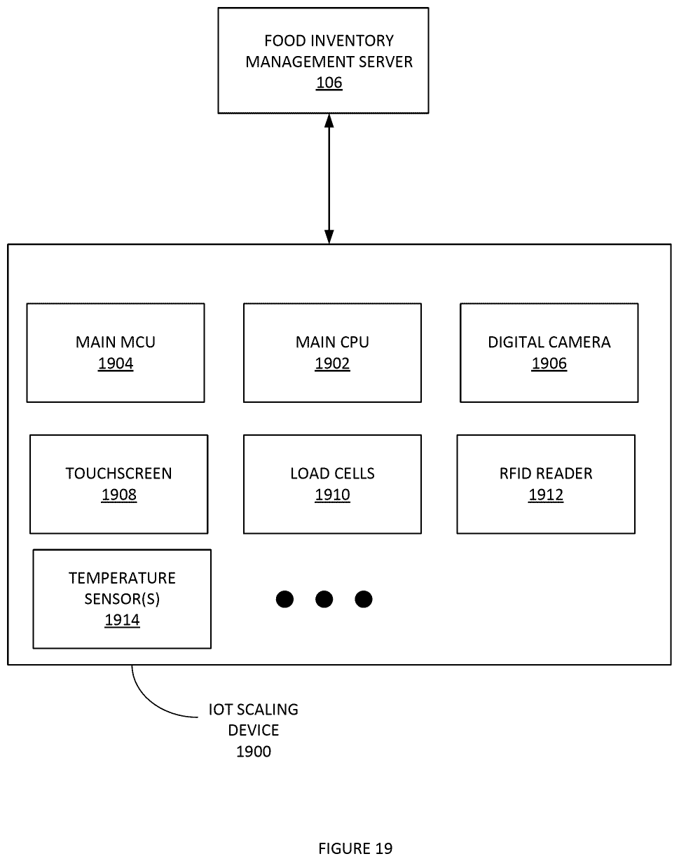

FIG. 19 illustrates an example IoT scaling device 1900, according to some embodiments. Food inventory management server 106 can interface with IoT scaling device 1900. IoT scaling device 1900 includes a main MCU 1904. IoT scaling device 1900 includes a digital camera 1906 for obtaining digital images of the produce/food items being processed. IoT scaling device 1900 includes a main CPU 1902. IoT scaling device 1900 includes one or more load cells 1910 for. IoT scaling device 1900 includes a touch screen 1908 to interface with a user. IoT scaling device 1900 includes an RFID reader 1912. IoT scaling device 1900 includes a temperature sensor(s) 1914 for sensing a current temperature.

### Additional Example Computer Architecture and Systems

An estimated expiration date predicted using an AI model as noted supra. Various ML/AI methods can be used to generate this AI food expiration date model. It is noted that the estimated expiration date showcases the extended shelf-life for each storage medium, including containers and bags. These expiration dates are determined through rigorous lab tests that we conduct repeatedly throughout the year. The AI modeling processes can take into account various factors in order to accurately determine the shelf-life, such as the growing origin of the fresh produce, the harvest season, the grade, and other relevant consideration. It is noted that lab results can be used as a training data set. Moreover, an ML model can be improved as more data is collected from customers to improve the shelf-life estimation.

A Machine learning (ML) module be provided and can implement various optimizations and models related to training the various AI models used herein. ML a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

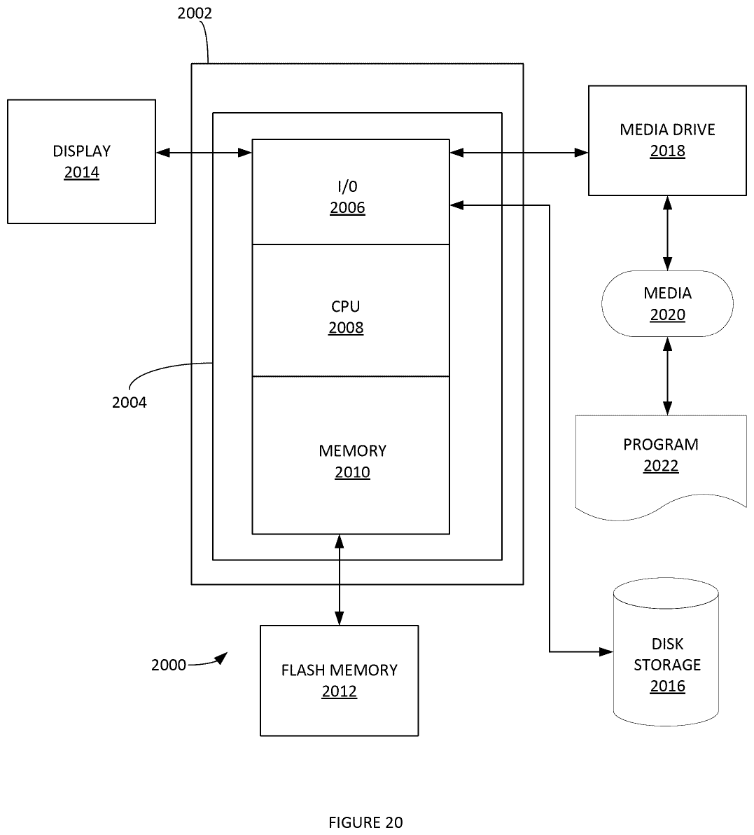

FIG. 20 depicts an exemplary computing system 2000 that can be configured to perform any one of the processes provided herein. In this context, computing system 2000 may include, for example, a processor, memory, storage, and I/O devices (e.g., monitor, keyboard, disk drive, Internet connection, etc.). However, computing system 2000 may include circuitry or other specialized hardware for carrying out some or all aspects of the processes. In some operational settings, computing system 2000 may be configured as a system that includes one or more units, each of which is configured to carry out some aspects of the processes either in software, hardware, or some combination thereof.

FIG. 20 depicts computing system 2000 with a number of components that may be used to perform any of the processes described herein. The main system 2002 includes a motherboard 2004 having an I/O section 2006, one or more central processing units (CPU) 2008, and a memory section 2010, which may have a flash memory card 2012 related to it. The I/O section 2006 can be connected to a display 2014, a keyboard and/or other user input (not shown), a disk storage unit 2016, and a media drive unit 2018. The media drive unit 2018 can read/write a computer-readable medium 2020, which can contain programs 2022 and/or data. Computing system 2000 can include a web browser. Moreover, it is noted that computing system 2000 can be configured to include additional systems in order to fulfill various functionalities. Computing system 2000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States Patent:

1. A method for automated fresh food inventory management, comprising:
sterilizing a food item using UV-C irradiation to deactivate a plurality of spoilage and harmful microorganisms using a UV-C light conveyor system;
after the sterilization using the UV-C irradiation, packaging the food item;
implementing a data collection about the food item comprising a package marking with information about the food item, a time of UV-C irradiation of the food item and a packaging information of the food item;
implements storage or shipping operations;
after the packaging process is completed, storing the packaged food item in a chiller on-site, wherein before shipping, when the packaged food item is loaded onto a delivery transport vehicle, a handheld terminal is used to instantly scan the RFID tags of all packages simultaneously;
tracking the packaged food item by obtaining and storing in a server:
a destination for transporting the packaged food item,
a quantity of each food type in kilograms,
at least one scan information of the packaged food item, and
at least one transportation status of the packaged food item; and
automatically monitoring a transportation status and a freshness status of the packaged food item.

2. The computerized method of claim 1, wherein the UV-C irradiation comprises a UV-C irradiation at a wavelength of two hundred and fifty-four nanometers (254 nm).

3. The computerized method of claim 2, wherein the UV-C light conveyor system comprises a touch screen and a control unit configured to enable an adjustment of UV-C irradiation dosages according to each specific type of fresh produce being treated.

4. The computerized method of claim 3, wherein the step of packaging the food item further comprises:
storing the food item in a Modified Atmosphere Packaging (MAP) bag.

5. The computerized method of claim 3, wherein the step of packaging the food item further comprises:
storing the food item in a vacuum container.

6. The computerized method of claim 1, wherein the data collection about the food item is stored with a unique RFID tag that is attached to the packaging.

7. The computerized method of claim 6, wherein the data collection about the food item is stored with a unique barcode or matrix code that is attached to the packaging.

8. The computerized method of claim 7, wherein the packaging process is completed at a distribution center.

9. The computerized method of claim 8, wherein each transport vehicle is equipped with a unique RFID tag that is also scanned during this process.

10. The computerized method of claim 8, wherein the RFID tag of the fresh produce packages is associated with a transport vehicle number and used to confirm a vehicle transport departure from the distribution center.
